(19) United States
(12) Patent Application Publication
(10) Pub. No.: US 2026/0205868 A1
(43) Pub. Date: Jul. 16, 2026

(54) UPLINK TRANSMISSION USING PDU SET-BASED PRIORITY WITHIN A QOS FLOW

(71) Applicant: InterDigital Patent Holdings, Inc., Wilmington, DE (US)

(72) Inventors: Michael STARSINIC, Newtown, PA (US); Jaya RAO, Montreal (CA); Xavier DE FOY, Kirkland, CA (US); Achref METHENNI, Montreal (CA)

(73) Assignee: InterDigital Patent Holdings, Inc., Wilmington, DE (US)

(21) Appl. No.: 19/136,562

(22) PCT Filed: Dec. 7, 2023
(86) PCT No.: PCT/US2023/082923

§ 371 Date: Jun. 6, 2025

Related U.S. Application Data
(60) Provisional application No. 63/430,880, filed on Dec. 7, 2022.

(51) Int. Cl. H04W 28/02

(52) U.S. Cl. CPC H04W 28/0268

(57) ABSTRACT

A wireless transmit receive unit (WTRU) and methods to transmit uplink protocol data units (PDUs) associated with a quality of service (QOS) flow with differing priority levels on a per-PDU basis are disclosed. A WTRU receives WTRU packet data unit (PDU) set detection rules from a network entity such as a session management function (SMF). The WTRU receives, from higher layers, a PDU associated with a quality of service (QOS) flow for uplink transmission. The WTRU determines a priority level of the received PDU, irrespective of the associated QoS, based on the WTRU PDU set detection rules and determines a data radio bearer (DRB) or logical channel to transmit the PDU based on the determined priority level. Additional embodiments are disclosed.

### CROSS-REFERENCE TO RELATED APPLICATIONS

This application claims the benefit of U.S. Provisional Application No. 63/430,880, filed Dec. 7, 2020, the contents of which is incorporated in its entirety herein by reference.

### BACKGROUND

Significant efforts are being applied to development of improved telecommunications equipment and services. In wireless communications, quality of service (QOS) and quality of experience (QoE) are important considerations for prioritizing communications and ensuring accurate and timely delivery of information based on assessed or designated importance.

In some network designs, the Priority Level associated with 5G QOS characteristics indicates a priority in scheduling resources among QOS Flows. Each QoS Flow may be associated with a QFI. For each QFI, the QoS Profile can indicate a 5QI value and a Priority Level that is associated with the QFI. When a Priority Level is included, it overrides the Priority Level that is associated with the 5QI. In other words, the Priority Level overrides the Priority Level that is associated with the 5QI. This “overriding” Priority Level is associated with a QOS Flow and indicates the priority of the QOS Flow relative to other QOS Flows.

In scenarios where QoS Flows carry packet data units (PDUs) of varying importance, a radio access network (RAN) should not treat all PDUs of the QoS Flow as having the same Priority Level. It would be better, from a user QoE perspective, if the RAN were to prioritize PDUs with relatively higher importance values. In other words, when making decisions about what PDUs to drop due to congestion, it would be preferable that the RAN drop low importance PDUs of different QoS Flows rather than only dropping PDUs from low priority QOS Flows.

In certain models, one QoS flow is mapped onto only one data radio bearer (DRB) at a time in the UL. Therefore, all UL PDUs of a QOS Flow will receive the same forwarding treatment and general prioritization in terms of what radio resources are allocated to each PDU. This approach may be sufficient when considering that each packet of a QoS Flow generally has the same characteristic, e.g., Packet Delay Budget. However, with the introduction of the PDU Set concept and the fact that individual PDU Sets that are sent in a QoS flow may vary in terms of importance, it may be desirable to determine and/or associate differing priority levels for PDUs within a same QoS downlink/uplink flow as described further below.

### SUMMARY

According to one aspect, if PDU Set based QoS handling is used, PDU Set Importance to Priority Level Mapping Rules may be signaled to the (R)AN, and if received, take precedence over the Priority Level that is associated with the QOS Flow and shall be used to assign a Priority Level to a PDU whose GTP-U header includes a PDU Set Importance value. Since this approach considers the flow priority and PDU Set Importance, the lower layers (e.g. RLC) can remain largely unaware of PDU Set Importance. In other words, the higher layers can be configured such that the flow priority and new PDU Set Importance is considered when determining priority and mapping to a logical channel.

According to certain embodiments, when a QoS Flow carries PDU Sets, a PDU Set Importance parameter may be used to identify the importance of one or more PDU Sets within the QoS flow. The PDU Set Importance parameter may then be used by a network or user equipment (UE), interchangeably referred to herein as a wireless transmit receive unit (WTRU), in determining what resources to assign to each packet. This enables a WTRU to assign resources for uplink transmission of PDUs to different DRBs based on the PDU Priority Level within the same QoS Flow. Thus, according to certain embodiments disclosed herein, enhancements are made to enable the service data adaption (SDAP) Layer of the WTRU to determine different a Priority Level for each UL PDU of a QoS Flow. The Priority Level that is determined by SDAP Layer may be based on a detected PDU Set Importance. One advantage of this enhancement is that the WTRU will be able to support certain procedures at the access stratum layers (e.g., logical channel prioritization, multiplexing, scheduling) that may result in suitable prioritization and allocation of more resources to PDUs that are part of higher priority PDU Sets and PDU Sets that share other QoS requirements, such as Packet Delay Budget, can still be mapped to the same QoS Flow.

This advantage and others may be achieved in devices and methods of communicating in a wireless network including a WTRU receiving packet data unit (PDU) set detection rules from a network, receiving a PDU associated with a QoS flow from upper layers for uplink transmission; determining a priority level of the received packet data unit (PDU), irrespective of the associated QoS, based on the PDU set detection rules; and assigning resources for uplink transmission of the PDU based on the determined priority level including assigning different data radio bearers (DRBs) for PDUs associated with the same QoS flow. In certain embodiments, PDU Set Detection Rules are received from a network entity such as the session management function (SMF) based on a triggering event. Determining a priority level of the PDU may be based on the received PDU Set Detection Rule and a PDU Set Importance value/indication associated with the PDU to be transmitted.

In other embodiments for downlink, when a QoS Flow carries PDU Sets, a PDU Set Importance parameter may be used to identify the importance of one or more PDU Sets within the QoS flow. The PDU Set Importance parameter may then be used by a RAN node to determine whether to schedule and/or what resources to assign to each DL packet. In certain cases, the RAN node may determine not to assign any resources to a DL packet. For example, during a period of congestion, the RAN may determine not transmit a DL packet that has a relatively low priority compared to other packets of a QoS Flow that need to be transmitted. Such an aspect may result in overall improved user experience because it is better, from QoE perspective, to drop certain PDUs of low importance across multiple QOS Flows, rather than dropping many PDUs from lower priority QOS flows. According to certain embodiments, methods and devices for downlink communication in a wireless network include a network node, e.g., a base station,: receiving a PDU set importance rule associated with a QoS Profile for a PDU Session from an SMF, receiving a PDU for downlink transmission, the PDU received in a GPT User plane (GTP-U) message including a header from a user plane function (UPF), determining a priority level of a packet data unit (PDU) based on the PDU set importance rule and information in the header of the GTP-U message including the PDU, and scheduling DL transmission of the PDU based on the determined priority level. Determining a priority level may include: receiving the GTP-U message including a header and the PDU, inspecting the header for an PDU Set Importance value, and comparing the PDU Set Importance value with a priority mapping rule set of the PDU set importance rule.

Variations and embodiments are disclosed to use a PDU Set importance parameter to accomplish this and other advantages as explained in further detail hereinafter.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows a message sequence diagram for wireless communications in a network using PDU-based priority levels and PDU set importance values in downlink QoS Flows according to one or more example embodiments;

FIG. 3 shows a flow diagram for a method of a base station communicating in a wireless network using PDU-based priority set priority rules according to an embodiment;

FIG. 4 is a message sequence diagram for a method and apparatus for wireless communications using PDU-set detection based priority levels in uplink QoS Flows according to one or more example embodiments; and

FIG. 5 shows a flow diagram for a method for a WTRU including PDU set detection based priority levels in uplink QoS Flows of an example embodiment.

### DETAILED DESCRIPTION

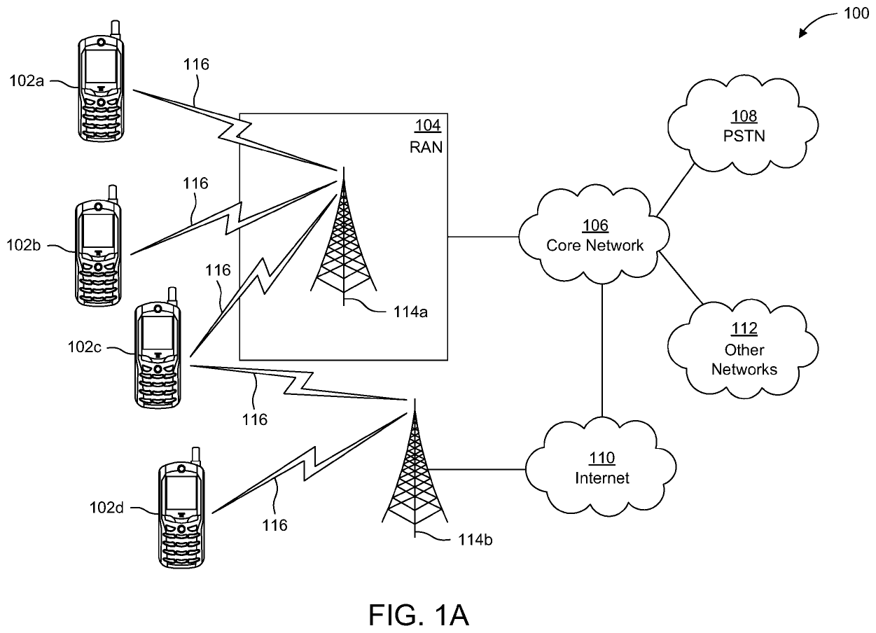

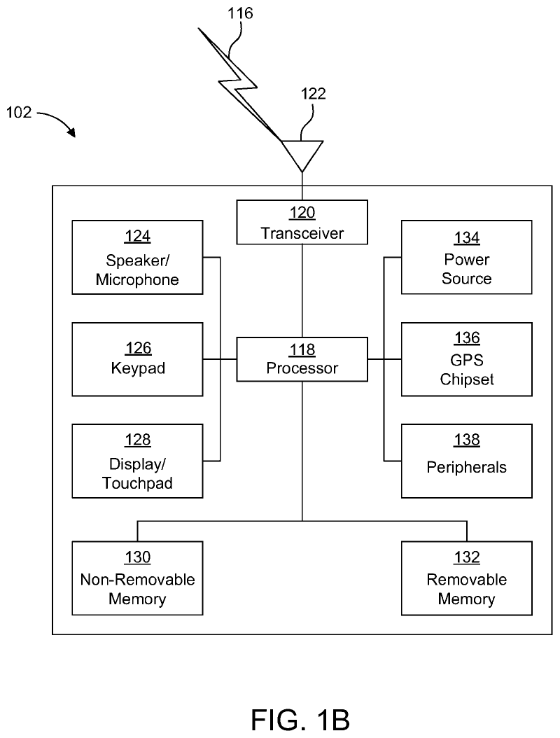

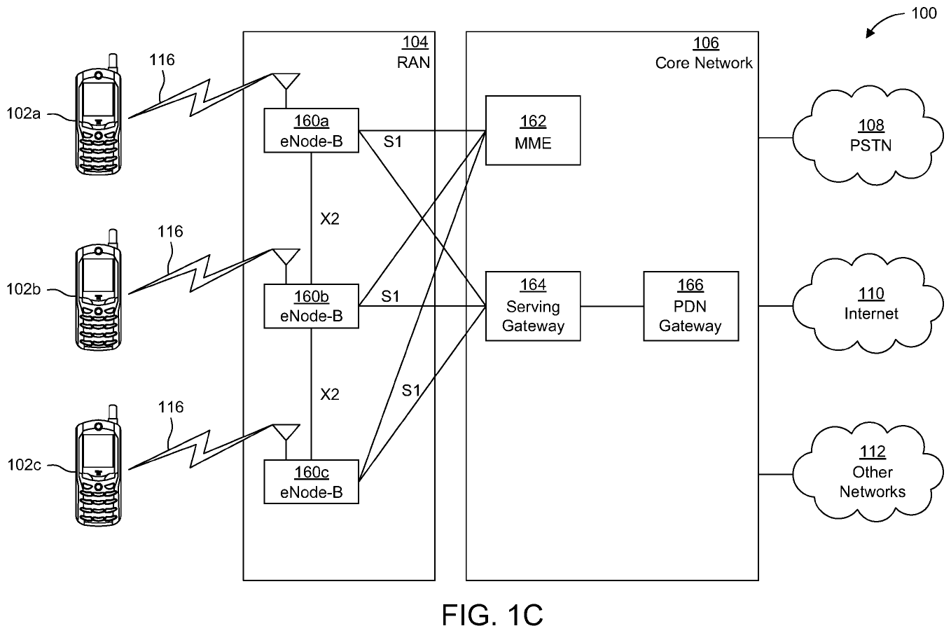

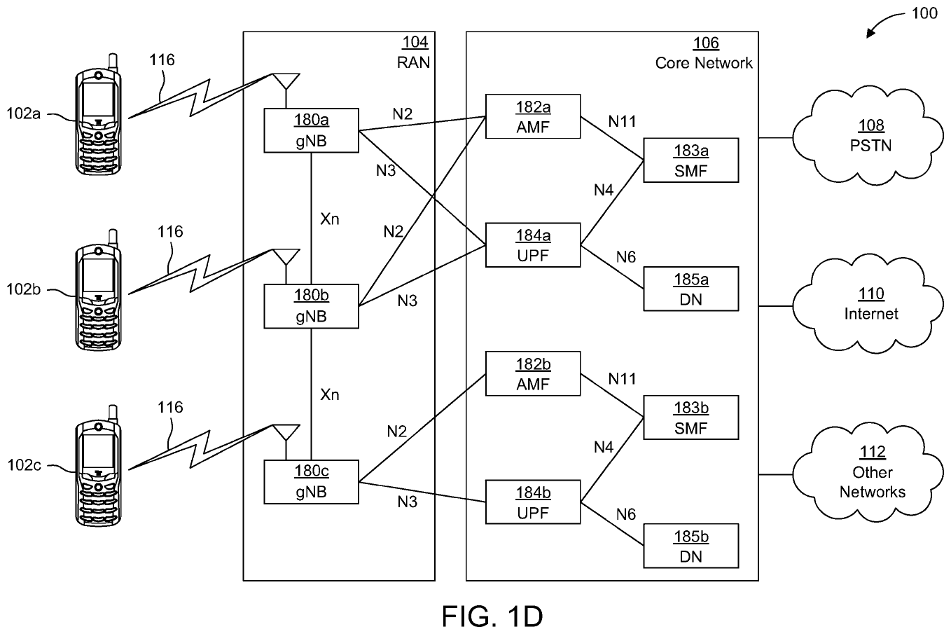

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUS 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11 ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. UPF 184 may be configured to perform PDU-based priority level processing in uplink QOS Flows as described herein. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. SMF 183 may be configured to perform PDU-based priority level processing in UL QOS Flow embodiments described herein. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different packet data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QOS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As used herein, the terms “RAN,” “RAN Node,” “gNB,” and “Base Station” are non-limiting examples which may be interchangeably referenced. The terms “packet” and protocol data unit “PDU” may also be used interchangeably in this disclosure describing example embodiments. The following description of specific examples is provided for improved understanding of the disclosed embodiments and the embodiments are not limited to any specific examples provided.

For QoS in the Downlink, a UPF assigns downlink packets to a QoS Flow based on rules that are configured in the user plane function (UPF), referenced previously, by the session management function (SMF), also described previously. A QOS Flow may be identified with a QOS Flow ID (QFI). The QFI is carried from the UPF to the RAN in an encapsulation header of a message. The (R)AN will map PDUs from QoS Flows to access-specific resources based on the QFI and an associated QOS profile. The QOS Profile that is associated with a QFI is generally configured in the RAN by the SMF. Generally, the SMF configures the UPF to detect what QoS Flow a downlink packet maps to and the SMF configures the RAN with information about the forwarding treatment that is required for each QoS Flow.

In example of fifth generation (5G) models, translating of 5G QI, referred to as “5QI,” to forwarding treatment characteristics, each QoS Flow is associated with a 5QI value. The 5QI is a scalar that is used as a reference to 5G QoS characteristics for access node-specific parameters that control QoS forwarding treatment for the QoS Flow (e.g. scheduling weights, admission thresholds, queue management thresholds, link layer protocol configuration, etc.). Each 5QI value may be translated into the following characteristics which are used in the DL to determine the packet forwarding treatment: a Resource type (Non-guaranteed bit rate (GBR), GBR, Delay-critical GBR); a Priority Level, a Packet Delay Budget (including Core Network Packet Delay Budget); a Packet Error Rate; an Averaging window (for GBR and Delay-critical GBR resource type only), and a Maximum Data Burst Volume (for Delay-critical GBR resource type only). The translation of the 5QI to the above listed characteristics is often based on a mapping table.

In configuring the UPF, the SMF uses an N4 interface to send a packet forwarding control protocol (PFCP) message with N4 Rules to the UPF. The PFCP message can include a packet detection rule (PDR) ID. The PDR that is identified by the PDR ID describes how the UPF can detect certain types of application traffic in the downlink. For example, the PDR can include an IP Packet Filter Set or an Application Identifier. The Application Identifier is an index to a set of application detection rules configured in UPF. The PFCP message can include QoS enforcement rule (QER) IDs. Each QER can include a QoS Flow ID (QFI) that UPF should include when forwarding downlink packets to the RAN node and to other UPFs. When the UPF detects traffic that matches the PDR, the UPF will use the QFI that is included in the QER.

For configuring the RAN Node, the SMF sends QoS Profiles for a PDU Session to the RAN node. QoS Profiles are sent to the RAN node in, for example, an N2 message via the access and mobility management function (AMF). The QoS Profiles can set up QoS Flows for the PDU Session. Each QoS Flow is associated with a QFI. For each QFI, the QoS Profile can indicate a 5QI value and a Priority Level that is associated with the QFI. When a Priority Level is included, it overrides the Priority Level that is associated with the 5QI. In other words, the Priority Level overrides the Priority Level that is associated with the 5QI in the mapping table.

The Priority Level associated with 5G QoS characteristics indicates a priority in scheduling resources among QoS Flows wherein the lowest Priority Level value corresponds to the highest priority. The Priority Level may be used to differentiate between QoS Flows of the same WTRU, and it may also be used to differentiate between QoS Flows from different WTRUs. In the case of congestion, when all QoS requirements cannot be fulfilled for one or more QoS Flows, the Priority Level is used to select for which QoS Flows the QoS requirements are prioritized. In the case of no congestion, the Priority Level should be used to define the resource distribution between QOS Flows.

PDU Sets relating to the packets that are delivered from the UPF to the RAN Node are PDUs. As previously mentioned, the concept of PDU Sets have been recently introduced and defined. A PDU Set is composed of one or more PDUs carrying the payload of one unit of information generated at the application level (e.g. a frame or video slice for XRM Services). In some implementations all PDUs in a PDU Set are needed by the application layer to use the corresponding unit of information. In other implementations, the application layer can still recover parts of the information unit, when some PDUs are missing.

PDU Set related information that can be identified by the UPF to support the handling of PDU Sets in the 5G System include: PDU Set Sequence Number; the End of a PDU Set; the PDU Sequence Number within a PDU Set; the PDU Set size; and, in the present embodiments, the PDU Set Importance. The PDU Set Information can be sent by the UPF to the RAN Node via a general packet radio service tunneling protocol unit (GTP-U) header of a user plane packet. In embodiments of the present disclosure, the RAN node can perform PDU Set based QoS handling based on PDU Set QoS Parameters that are received via the control plane and the PDU Set Information received via user plane in a GTP-U header as explained further below. Further, as described in embodiments below, the PDU Set Importance parameter may be used to identify the importance of a PDU Set within a QoS flow and, for example, the RAN may use it for PDU Set level packet discarding in presence of congestion.

The service data adaptation protocol (SDAP) layer of the WTRU maps QoS Flows to data radio bearers (DRBs) in the uplink (UL). One or more QoS flows may be mapped onto one DRB and, prior to the embodiments disclosed here, one QoS flow is mapped onto only one DRB at a time in the UL.

Problems related to downlink data. As described above, the Priority Level that is associated with a QOS Flow indicates that the priority of the QOS Flow relative to other QOS Flows. When a QOS Flow carries PDU Sets, the PDU Set Importance parameter of disclosed embodiments, is used to identify the importance of a PDU Set within the QoS flow. Currently, the RAN node is only able to determine a single priority value for all the packets in a QoS Flow. This priority is then used by the RAN node to determine whether to schedule and/or what resources to assign to each DL packet, and sometimes used by the RAN node to determine not to assign any resources to a DL packet. For example, during a period of congestion, the RAN may determine to not transmit a DL packet belonging to a QoS Flow having relatively low priority compared to the packets of QoS Flow with higher priority, thereby dropping some or all of an entire QoS level flow having low priority.

Because of the introduction of the PDU Set concept and the fact that PDU Sets that are sent in a QOS flow may individually vary in terms of importance, embodiments of the present disclosure enable the RAN node to determine the priority of DL packets (i.e., PDUs) within the same QoS flow. Example embodiments provide an overall improved user experience because it is better, from QoE perspective, to drop PDUs of low importance across all QoS Flows rather than only dropping PDUs from low priority QoS flows.

Problems Related to Uplink Data. As described above, currently, one QOS flow is mapped onto only one DRB at a time in the UL. Therefore, all UL PDUs of a QoS Flow will receive the same forwarding treatment and general prioritization in terms of what radio resources are allocated to each PDU. This approach may be sufficient when considering that each packet of a QoS Flow generally has the same Packet Delay Budget. However, with the introduction of the PDU Set concept and the fact that PDU Sets that are sent in a QoS flow may vary in terms of respective importance, embodiments of the present disclosure may utilize the access stratum protocol layers of the WTRU to provide a particular forwarding treatment during UL transmission according to attributes of the PDU set. The forwarding treatment may include any of the procedures supported at the protocol layers of the WTRU for ensuring QoS such as mapping of PDUs to preconfigured logical channels, performing logical channel prioritization, multiplexing of PDUs in logical channels to transport blocks and scheduling. In an example, the service data adaptation protocol (SDAP) Layer of the WTRU may determine the priority of UL packets (i.e. PDUs) within a QoS flow and use this priority information to map the packets to different DRBs configured with associated priority values. The SDAP layer may provide the priority information to the PDCP Entity of the WTRU (e.g. via the PDCP service data unit (SDU) header) so that the priority level information can be considered when providing a suitable forwarding treatment and using the resources allocated by the base station during UL data transmission.

According to some embodiments, the RAN Node may determine a different Priority Level for each DL PDU of a QoS Flow. The Priority Level that is determined by the RAN Node may be based on a detected PDU Set Importance. One advantage of these embodiments is that the scheduler of the RAN Node will be able to assign more resources to PDUs that are part of higher priority PDU Sets and PDU Sets that share other QoS requirements, such as Packet Delay Budget, can still be mapped to the same QoS Flow.

Further embodiments enable the SDAP) Layer of a WTRU to determine a different Priority Level for each UL PDU of a QoS Flow. The Priority Level that is determined by the SDAP Layer may be based on a detected PDU Set Importance. An advantage of these embodiments, is that the WTRU will be able to support certain procedures at the access stratum layers (e.g., logical channel prioritization, multiplexing, scheduling) that may result in suitable prioritization and allocation of more resources to PDUs that are part of higher priority PDU Sets and PDU Sets that share other QoS requirements, such as Packet Delay Budget, can still be mapped to the same QOS Flow.

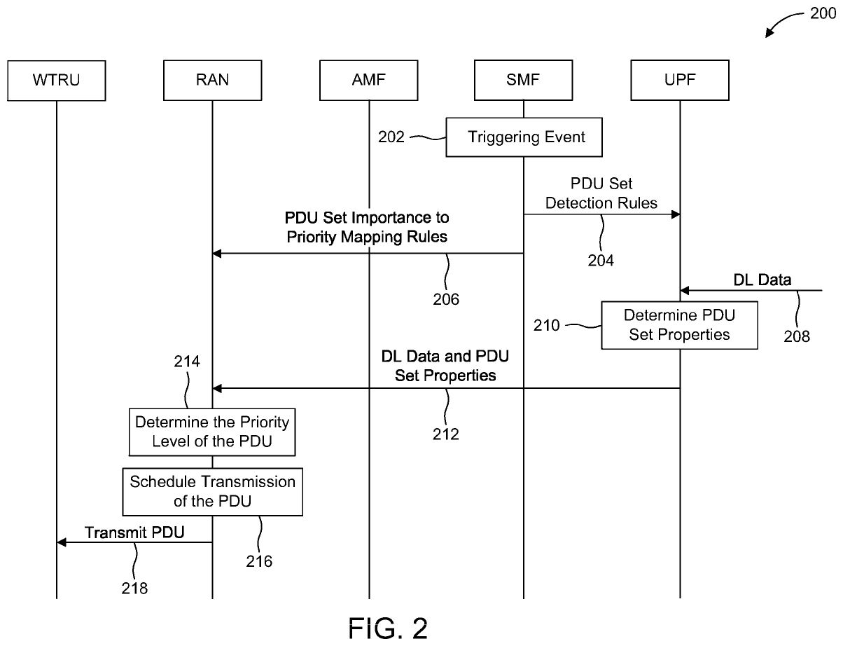

Referring to FIG. 2, a method 200 for PDU set priority determination for downlink transmission according to one example embodiment is shown. A radio access network (RAN) node, e.g., a base station, may implement per-PDU priority level determination for downlink traffic as follows. A RAN node may receive 206 PDU Set Importance Rules (PDUSIRs), also referred to herein as a rule set, and a QoS Profile for a PDU Session from an SMF. It should be noted that further steps configuring the RAN node's receipt of this information may vary as shown in FIG. 2, including a triggering event occurring 202, such as high congestion occurrence at the SMF or the like. The SMF may pass 204 PDUSIRs to the UPF based on the triggering event 202 or for each new QoS Flow, depending on preference and efficiency desired. Examples of steps 202 and 204 of FIG. 2 are discussed later below.

The RAN node receives 212 the PDUs from the UPF. In one example embodiment, the PDU may be received 212 as a general packet radio system/service (GPRS) tunneling protocol unit (GTP-U) message. In this example, the GTP-U message may include a header identifying a priority level of the associated PDU it carries. Next, the RAN node uses information from the GTP-U message header and the PDU Set Importance Rules (received at 206) to determine 214 a PDU set-based Priority Level for the associated PDU for downlink transmission.

The RAN Node uses the determined PDU set-based Priority Level to determine 216 what network resources to use/schedule in transmitting 218 the PDU to a WTRU. In some example embodiments, the PDU Set Importance Rules that are received by the RAN Node at step 206, may be included as part of a QoS Profile. In one example, the PDU Set Importance Rules that are received by the RAN Node may be part of a Non Dynamic 5QI Descriptor.

In alternative embodiments the PDU Set Importance Rules that are received 206 by the RAN Node may be part of a Dynamic 5QI Descriptor. In other embodiments, PDU Set Importance Rules may be a separate or standalone rule set. Preferably, an indicator may be used to identify an incoming PDU quality characteristic and matched to a pre-defined rule set, although the embodiments are not so limited. The PDU Set Importance Rules may be rules for how to map PDU Set Importance values of DL PDUs within the QoS Flow to one or more differing Priority Levels.

In one embodiment, the PDU Set Importance Rules may include one or more Common ID(s) and the RAN Node may receive a message from the SMF that indicates that one or more Common ID(s) are associated with the PDU Session. The GTP-U message header may indicate a PDU Set Importance value. For example, the GTP-U message header may include a PDU Type field and the value of the PDU Type field is used by the RAN node to determine that PDU Set Importance Rules are associated with the PDU.

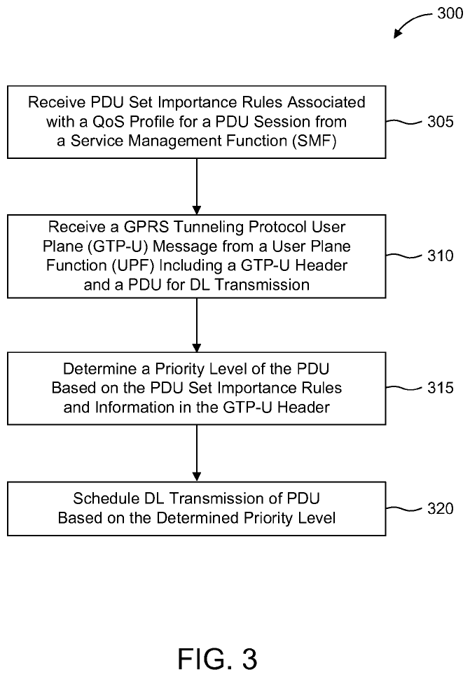

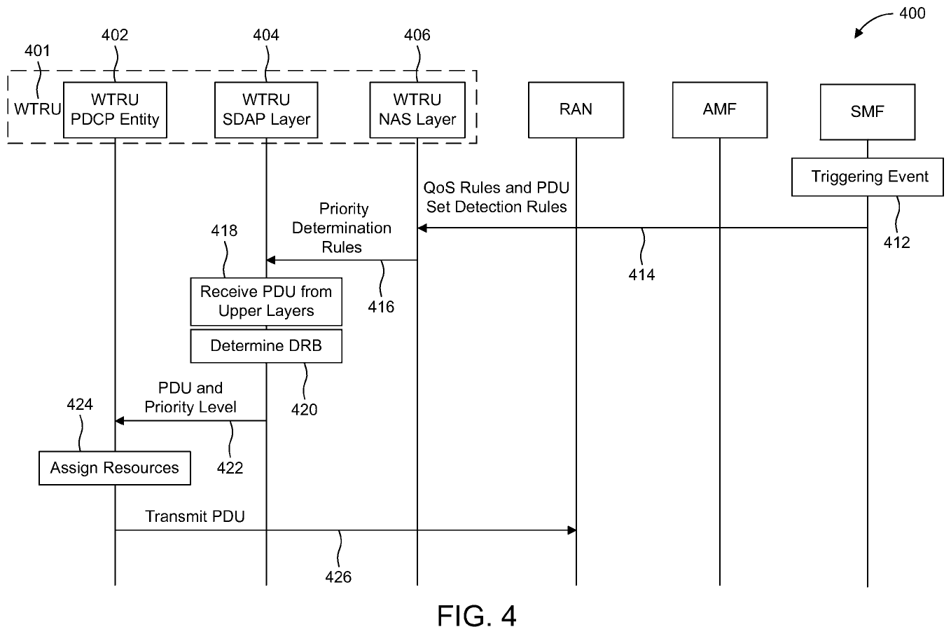

Referring to FIG. 3, an example method 300 is shown for a base station using PDU-set importance rule-based Priority Level determinations in downlink transmissions according to one embodiment. Initially, the base station receives 305 PDU Set Importance Rules associated with a QoS flow for a PDU session, from a SMF. Next, the base station receives 310 a GTP-U message from the UPF which includes a header and a payload with a PDU/PDU set for downlink transmission. The base station identifies information from the GTP-U header, e.g., a PDU set importance value, and determines 320 a Priority Level of the PDU for DL transmission based on the PDU set importance value and corresponding PDU Set Importance Rule. The base station may then schedule 320 the DL transmission of the PDU to a WTRU based on the determined Priority Level. Although not shown, subsequent PDUs of the PDU session may be received and have differing priority levels determined. In this manner, the Priority Level of each PDU scheduled and transmitted by the base station may be different within the same QoS flow. In some embodiments, when the base station determines a congestion event, the base station may determine to drop certain PDUs. In other words, the base station may determine to cancel the transmission of PDUs which are determined to have lower priority than other PDUs of the same QOS Flow. Referring to FIG. 4, a method 400 is shown for applying PDU-based Priority Level Determination by a wireless transmit receive unit (WTRU) for UL traffic according to various embodiments. As shown in FIG. 4, a WTRU 401 may be divided into three different entities, a packet data convergence protocol (PDCP) entity 402, a service data adaptation protocol (SDAP) Layer 404 and a non-access stratum (NAS) layer 406 In this example, the WTRU 401 may receive 414 WTRU PDU Set Detection Rules from an SMF at its NAS layer 406. When the WTRU 401 receives 418 a PDU for UL transmission, for example, from upper layers to SDAP layer 404, the WTRU PDU Set Detection Rules are used to determine a Priority Level of a PDU. The WTRU uses the determined Priority Level to determine 420 a data radio bearer (DRB) to use to transmit the PDU.

In various embodiments, the WTRU PDU Set Detection Rules may be received 414 by the WTRU 401 in a PDU Session Establishment Accept message, or alternatively, in a PDU Session Modification Command. In certain embodiments, the WTRU PDU Set Detection Rules may be received 414 by the WTRU non-access stratum (NAS) Layer 406, which is a functional layer in wireless network protocol layers between the core network and WTRUs to manage the establishment of communication sessions and maintain them as the WTRU moves. In one example, the WTRU PDU Set Detection Rules may be sent 416 by the WTRU NAS Layer 406 to the WTRU service data adaption protocol (SDAP) Layer 404.

In various example embodiments, the WTRU PDU Set Detection Rules may include a quality of service (QOS) Flow Indicator (QFI) and the QFI may be used by the WTRU to determine what QoS Flow(s) to which the WTRU PDU Set Detection Rules apply. According to some example embodiments, the WTRU PDU Set Detection Rules may include a Priority Determination Rule and the Priority Determination Rule (step 416) may indicate a value that may be compared to at least part of the header of an incoming PDU, at step 418, and the result of the comparison can be used to determine a priority level for the respective PDU set. The WTRU may determine a QFI that is associated with an incoming PDU and use the QFI to determine what WTRU PDU Set Detection Rule to use to determine the Priority Level of the packet. The Priority Level may also be used to determine/select a resource (e.g. logical channel) to be used for transmitting the PDU in the uplink.

In various downlink embodiments disclosed herein, the Session Management Function (SMF) may configure a PDU Session for Per PDU Priority Level Determination as described in reference to FIG. 2. In one example, an SMF detects a triggering event (202; FIG. 2). Based on the triggering event, the SMF sends PDU Set Detection Rules for a PDU Session to a UPF (204; FIG. 2). The PDU Set Importance Rules and a QoS Profile for a PDU Session may be sent 206 to a RAN Node.

In embodiments for UL PDU-based Priority Levels, e.g., FIG. 4, the SMF may alternatively, or in addition, send (414; FIG. 4) WTRU PDU Set Detection Rules to a WTRU. In some examples, as shown in FIG. 4, the triggering event 412 at the SMF, may be reception of a PDU Session Establishment Request, determining to send a PDU Session Modification Command, or the reception of policy and charging control (PCC) Rules from a policy control function (PCF) (not shown in FIG. 4).

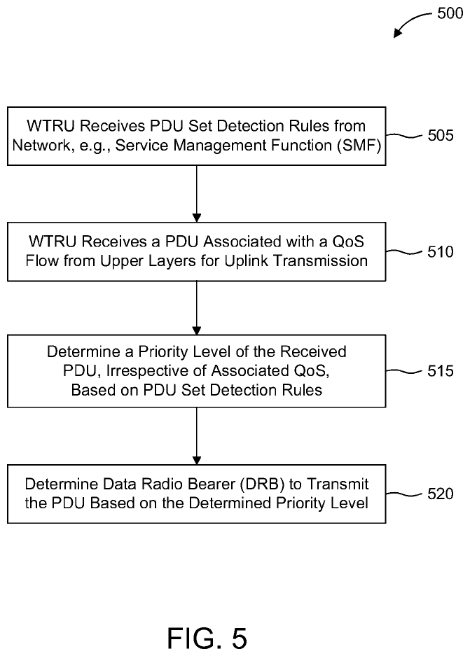

The PDU Set Detection Rules of the embodiments described herein, may indicate to the UPF how to determine the relative importance of a PDU Set. As described herein, there may be two basic entities performing PDU-based priority level indication involved, depending on whether PDU flow is in the downlink or the uplink. The rules used by the base station or RAN node (FIGS. 2-3), are referred to as Network PDU Set Importance Rules and the rules applied by the WTRU (FIGS. 4-5) are referred to as WTRU PDU Set Detection Rules. Specific implementations may vary, without departing from the scope of the embodiments to further divide QoS Flows into PDU set-based priority levels.

For the downlink referenced in FIG. 2, the Network PDU Set Importance Rules that are sent by the SMF may be part of a QoS Profile. In example embodiments, Network PDU Set Importance Rules that are sent by the SMF may be part of a Non Dynamic 5QI Descriptor or be part of a Dynamic 5QI Descriptor and/or generally include rules for how to map PDU Set Importance values from the QoS Flow to a PDU-based Priority Level. In example embodiments, the Network PDU Set Importance Rules may include one or more Common ID(s) and the RAN Node may receive a message from the SMF that indicates that one or more Common ID(s) are associated with the PDU Session.

For the uplink, the WTRU PDU Set Detection Rules referenced in FIG. 4, may be sent by the SMF in, for example, a PDU Session Establishment Accept message or a PDU Session Modification Command. In some example embodiments, the WTRU PDU Set Detection Rules may include one or more indicators, e.g., a QFI, and one or more Priority Determination Rules for indicator-based application of Priority Levels to assign to PDUs within a QoS Flow.

In FIG. 2, determining the priority of DL PDUs in the RAN based on SMF signaling, the SMF may send 206 QoS Profiles for a PDU Session to the RAN Node. The QoS Profiles may be sent to the RAN Node during a PDU Session Establishment or PDU Session Modification procedure. In order to enable the RAN Node to determine the priority of PDUs within a QOS Flow, instead of a single priority for all PDUs in a QoS Flow, the SMF may include PDU Set Importance rules in a QoS Profile. The QoS Profile may be sent to the RAN Node by the SMF, for example, in a PDU Session Resource Setup Request Transfer Information Element or a PDU Session Resource Modify Request Transfer. The QoS Flow information may be sent to the RAN Node in a QOS Flow Setup Request Item or QOS Flow Add or Modify Request Item. For one example, the QoS Profile includes a QOS Flow Level QoS Parameters next generation application protocol (NGAP) Information Element or similarly functional signaling. The QoS Profile may include a Non Dynamic 5QI Descriptor or a Dynamic 5QI Descriptor as described previously. Moreover, in certain embodiments, theses Non Dynamic 5QI Descriptor and/or Dynamic 5QI Descriptor may be enhanced so that they include a rule for how to map PDU Set Importance values from the QoS Flow to a Priority Level.

The QoS Profile of certain embodiments, may include an indication that the PDU Set feature is enabled, thus indicating to the RAN Node that the QoS Flow will be used to receive DL PDU Sets to be distinguished. This indication may trigger the RAN Node to check the headers of packets destined for DL transmission for information about the PDU Set associated with a DL PDU. Alternatively, the SMF may send PDU Set Importance Rules to the RAN Node in a message that is independent of any PDU Session. The Network PDU Set Importance Rules may include one or more identifiers (e.g., Common ID(s). The SMF may then indicate to the RAN Node what PDU Set Importance Rules should be applied in a PDU Session by including a Common ID in the PDU Session Resource Setup Request Transfer Information Element or a PDU Session Resource Modify Request.

In the example embodiment of FIG. 2, when a NG-RAN node receives 212 a DL PDU from a UPF, the RAN node may perform a procedure to determine the Priority Level of the PDU instead of using the QFI of the PDU to directly map to a Priority level. An example of this procedure for determining the priority of a PDU, the RAN node may check if the following conditions are true: (1) whether the header of the PDU indicates a PDU Set Importance value; and (2) whether a Non Dynamic 5QI Descriptor or Dynamic 5QI Descriptor of the QOS Flow includes a rule for how to map PDU Set Importance values from the QoS Flow to a Priority Level. This rule is referred to herein as “a PDU Set Importance to priority level mapping rule,” and is shown being sent 206 to the RAN Node by the SMF.

If both of the above conditions are true, then the RAN Node may overlook or disregard the Priority Level that is normally associated with the 5QI of the QoS Flow and the RAN node will not consider any Priority Level that is included in the Non Dynamic 5QI Descriptor or Dynamic 5QI Descriptor of the QoS Flow. Instead, the RAN Node will use the PDU Set Importance to Priority Level Mapping Rule to determine the Priority Level of the PDU.

As previously described, embodiments of Network PDU-based Priority Levels may include, a triggering event occurring (202; FIG. 2) in the SMF, such as a PDU Session Establishment procedure, a PDU Session Modification procedure, or the reception of new PCC Rules from the PCF. The SMF sends 204 PDU Set detection rules to the UPF to determine how to inspect incoming DL packets and determine information about the PDU Set that the DL packets are associated with. PDU Set detection rules are described in greater detail below.

Referring again to FIG. 2, the SMF may send an N2 message to the RAN Node. The N2 message may be sent to the RAN node via the AMF. The N2 message in this example, includes QoS Profile(s) for the PDU Session which include a PDU Set Importance to Priority Level Mapping Rule. At step 4, the UPF receives 208 a downlink packet, for example, from an application. At 210, the UPF inspects the properties (i.e., content) of the downlink packet and uses the determined properties and the PDU Set detection rules it received from the SMF in step 204, to determine 210 if the packet is the first PDU of a PDU Set, the last PDU of a PDU Set, the PDU Sequence Number within a PDU Set, the PDU Set size, and the PDU Set Importance. An example of this operation is further described below.

If, the UPF is able to determine 210 PDU Set information for the downlink packet, the UPF will send 212 the downlink packet to the RAN Node, for example, in a GTP-U message. As previously mentioned, the header of the GTP-U message may include the determined PDU Set information, including the PDU Set importance information. An example of this operation is further described below.

In FIG. 2, the RAN Node receives 212 the PDU and the associated PDU Set Information in the GTP-U header. The RAN node uses the PDU Set importance information from the header and the PDU Set Importance to priority level mapping rule that was received in step 206 to determine 214 a Priority Level for the PDU downlink transmission. If no PDU Set importance information is included in the header or no Priority Level is determined using the mapping rule, then the RAN Node may determine the Priority Level of the PDU based on the 5QI or the Priority Level that was indicated in the QoS Profile. In other words, if PDU Set-based QoS handling is used (i.e., the PDU Set feature is enabled for the PDU Session), PDU Set Importance to priority level mapping rules may be signaled to the (R)AN, and if received, take precedence over the Priority Level that is associated with the entire QoS Flow and can be used to assign a Priority Level to a PDU whose GTP-U header includes a PDU Set Importance value.

Next, the RAN Node uses the Priority Level to schedule 216 transmission of the DL PDU to the WTRU or to determine to not transmit the DL PDU (e.g., due to congestion). Unless the RAN node determined to not transmit the DL PDU in step 216, e.g., due to congestion, the RAN Node transmits 218 the DL PDU to the WTRU.

The PDU Set Importance Rules that are received by the RAN Node may be part of a QoS Profile and include rules for how to map PDU Set Importance values from the QoS Flow to a Priority Level. The PDU Set Importance Rules that are received by the RAN Node may be part of a Non Dynamic 5QI Descriptor or a Dynamic 5QI Descriptor.

In some embodiments, the PDU Set Importance Rules may include one or more Common ID(s) and the RAN Node may receive a message from the SMF that indicates that one or more Common ID(s) are associated with the PDU Session. As mentioned, the GTP-U message header may indicate a PDU Set Importance value. The GTP-U message header may include a PDU Type field and the value of the PDU Type field is used by the RAN node to determine that PDU Set Importance Rules are associated with the PDU.

Embodiments for a user plane function (UPF) determining PDU Set information are now described. As mentioned above in reference to FIG. 2, the UPF may be configured with PDU Set detection rules, e.g., received from the SMF via the N4 interface. The PDU Set detection rules may be used by the UPF to determine how to inspect incoming packets and determine information about the PDU Set associated with the DL packets. For example, the UPF may determine the PDU Set Sequence Number associated with the packet and may, for example, further determine if the packet is the first PDU of a PDU Set, the last PDU of a PDU Set, the PDU Sequence Number within a PDU Set, the PDU Set size, and the PDU Set Importance. The PDU Set detection rule(s) may indicate to the UPF how to determine the relative importance of the PDU Set. For example, the PDU Set detection rule may indicate that a relatively high importance should be assigned to PDU Set when it is observed that the incoming packet includes certain information in the header. The PDU Set detection rule may indicate that a relatively low importance should be assigned to PDU Set when it is observed that the incoming packet includes certain other information in the header.

Embodiments for UPF Indication of PDU Set information to the RAN Node are now described. As mentioned above, the PDU Set Information can be sent by the UPF to the RAN Node via a GTP-U header of a user plane packet (i.e., a PDU). The RAN node can perform PDU Set-based QoS handling based on PDU Set QoS Parameters that are received (step 206; FIG. 2) via the control plane and the PDU Set Information that was received (step 212; FIG. 2) via user plane in a GTP-U header. The information that is included in the header may include a PDU Set Sequence Number, the End of a PDU Set, the PDU Sequence Number within a PDU Set, the PDU Set size, and a PDU Set Importance. The format of PDU Session user plane protocol data that can be carried from the UPF to the RAN node in a GTP-U header may be defined. One example existing protocol defines two different structures of PDU Session user plane frames. The type of frame is indicated in a 4-bit PDU Type information element in the header. The first type of structure is DL PDU SESSION INFORMATION (PDU Type 0) and the second type of structure is UL PDU SESSION INFORMATION (PDU Type 1). Certain embodiments herein, may define a third type of structure for the case where PDU Set information needs to be sent from the UPF to the RAN node. In an example, the third type of structure may be called DL PDU SESSION INFORMATION FOR PDU SETS (PDU Type 2). This header may include fields that allow the UPF to indicate information to the RAN node such as PDU Set Sequence Number, the End of a PDU Set, the PDU Sequence Number within a PDU Set, the PDU Set size, and PDU Set Importance. Furthermore, the applicability of the PDU Set feature to the packet may be indicated to the RAN Node by virtue of the PDU Type field being set equal to 3.

The PDU Set Importance value or indication may be one or more bits and may be used to indicate the importance of the PDU Set relative to other PDU Sets of the same QoS Flow. For example, a value of 1 may indicate lower importance than a value of 0. The PDU Set Importance information may be sent to the RAN Node by the UPF for every packet where a PDU Set Importance value is determined. Alternatively, the PDU Set Importance information may be sent to the RAN Node only with the first PDU of a PDU Set and the RAN may then assume that all subsequent PDUs of same PDU Set are of the same importance. When no PDU Set information is determined by the UPF, the UPF may use DL PDU SESSION INFORMATION (PDU Type 0) to send the DL data of the QoS Flow to the RAN Node.

Examples of determining the Priority of UL PDUs in the WTRU based on SMF Signaling follow. As mentioned previously in respect to FIG. 4, a WTRU may receive 414 WTRU PDU Set Detection Rules from an SMF, e.g., in a PDU Session Establishment Accept or a PDU Session Modification Command. The WTRU PDU Set Detection Rules may be used by the SDAP layer and may be an information element that includes the following information, by way of example. First, a QFI that indicates to the WTRU to which QoS Flow the WTRU PDU Set Detection Rules apply. Second, a Priority Determination Rule is used by the SDAP layer of the WTRU to determine the Priority Level of the PDUs of a PDU Set. For example, the Priority Determination Rule may indicate that a relatively high Priority Level should be assigned to the PDUs of a PDU Set when it is observed that the incoming UL packet of the QoS Flow includes certain information in the header. Whereas the Priority Determination Rule may indicate that a relatively low importance should be assigned to the PDUs of the PDU Set when it is observed that the incoming UL packet of the QoS Flow includes certain other information in the header. In one example, the application may provide metadata to the SDAP layer. For example, an application (or library used by the application) can call an application program interface (API) associating an importance parameter with a “send” or “write” call to a socket. This importance parameter may be carried down the stack towards the SDAP API.

In certain example embodiments, the priority level can indicate a fixed priority (e.g., low, normal, high). In another example embodiment, the priority level can be a number that is used by the WTRU protocol stack to determine the relative priority between PDUs (sets). For example, if PDUs are queued with priority 10, 11 and 12, the stack will provide high priority treatment to 12, and low to 10, or visa versa, depending on how one rates priority levels.

Once the SDAP layer determines the Priority Level, the SDAP layer may use the Priority Level to determine what data radio bearer (DRB) in which to map to the UL packet of the QOS Flow. In other words, the SDAP Layer may be enhanced and/or configured so that this Priority Level information is used to map the packet of a single QOS flow to different DRBs. The SDAP layer may also provide the Priority Level to the PDCP Entity of the WTRU so that the PDCP Entity of the WTRU can use the Priority Level to determine what forwarding treatment (e.g., logical channel) and/or resource to use to transmit the UL packet.

As shown in FIG. 4, the example method 400 of wireless communication using PDU-based Priority Levels in uplink transmission, may include a triggering event occurring 412 in the SMF. The triggering event may be a PDU Session Establishment procedure, a PDU Session Modification procedure, or the reception of new PCC Rules from the PCF. The SMF sends 414 PDU Set Detection Rules to the WTRU. The PDU Set Detection Rules may be sent in a PDU Session Establishment Accept message or a PDU Session Modification Command. The PDU Set Detection Rules may include Priority Determination Rules in which, the WTRU NAS Layer 406 sends 416 the Priority Determination Rules for the PDU Session to the WTRU SDAP Layer 404. The WTRU SDAP layer 404 receives 418 a PDU from the WTRU upper layers and also may receive a PDU Set Importance value or indicator from the WTRU upper layer, e.g., application layer, when it receives the PDU. The WTRU SDAP layer 404 uses the Priority Determination Rules to determine the Priority Level of the PDU that was received and uses the determined Priority Level to select 420 a DRB to transmit the PDU in the uplink. The determined Priority Level may be irrespective of a QoS of the flow.

The WTRU SDAP Layer 404 may send 422 the PDU and determined Priority Level to the WTRU PDCP Entity 402, which, along with lower layers, use the Priority Level to determine 424 what forwarding treatment and/or resources to use to transmit the PDU (e.g., what logical channel to use to send the PDU). The WTRU will use the forwarding treatment and/or resources that were determined previously, to transmit 426 the PDU or, possibly, determine not to transmit the PDU.

As described above, in certain example embodiments, each QoS Flow is associated with a 5QI value and each 5QI value may be translated into the following characteristics, one or more of, which may be used in the determining the packet forwarding treatment, e.g., setting a Priority Level per PDU:
A Resource type (Non-GBR, GBR, Delay-critical GBR),
A Priority Level,
A Packet Delay Budget (including Core Network Packet Delay Budget),
A Packet Error Rate,
An Averaging window (for GBR and Delay-critical GBR resource type only), and
A Maximum Data Burst Volume (for Delay-critical GBR resource type only).

For each QFI, the QoS Profile can indicate a 5QI value and a Priority Level that is associated with the QFI. When a Priority Level is included, it overrides the Priority Level that is associated with the 5QI. In other words, the Priority Level overrides the Priority Level that is associated with the 5QI in the mapping table. The Priority Level associated with 5G QOS characteristics indicates a priority in scheduling resources among QoS Flows.

In the downlink, currently, the RAN node is only able to determine a single priority value for all the packets in a QoS Flow. Embodiments described herein provide for system enhancements so that a RAN node can individually determine the priority of DL packets (i.e. PDUs) within a QoS flow.

In the uplink, currently, all UL PDUs of a QoS Flow will receive the same general prioritization in terms of what radio resources are allocated to each PDU, e.g., packets in the same QoS Flow are assigned the same DRB in the uplink. Embodiments described herein provide for system enhancements so that the SDAP Layer of the WTRU can determine the priority of UL packets (i.e. PDUs) within a QoS flow and use this priority information to map packets to different DRBs. Further, embodiments may provide the priority information to the PDCP Entity of the WTRU so that the priority level information can be considered when determining what resources to attempt to allocate to the PDU.

Thus, embodiments described herein may provide a Per PDU Priority Level Determination for DL Traffic including: a RAN Node including a transceiver and a processor configured to perform one or more actions including: receiving PDU Set Importance Rules and a QoS Profile for a PDU Session from an entity such as an SMF and receiving a message from an entity such as a UPF. The message includes a PDU and a message header designating a priority level of the PDU within a QoS Flow. In one embodiment, the message including a PDU is received in a GTP-U message.

The processor in the RAN Node uses information from the GTP-U message header and the PDU Set Importance Rules to determine a Priority Level to associate with the PDU and determines what network resources to use in transmitting the PDU to another device, such as a WTRU, based on the determined PDU Priority Level.

The PDU Set Importance Rules that are received by the RAN Node may be part of a QoS Profile and include rules for how to map PDU Set Importance values from the QOS Flow to a Priority Level. The PDU Set Importance Rules that are received by the RAN Node may be part of a Non Dynamic 5QI Descriptor or a Dynamic 5QI Descriptor.

The PDU Set Importance Rules may include one or more Common ID(s) and the RAN Node may receive a message from the SMF that indicates that one or more Common ID(s) are associated with the PDU Session. The GTP-U message header may indicate a PDU Set Importance value. The GTP-U message header may include a PDU Type field and the value of the PDU Type field is used by the RAN node to determine that PDU Set Importance Rules are associated with the PDU.

Referring to FIG. 5, a method 500 for a WTRU using Per PDU Priority Level Determination for UL traffic of a QoS flow is shown. A WTRU may include a transceiver and a processor coupled to the transceiver and configured to perform method 500. Initially, the WTRU receives 505 WTRU PDU Set Detection Rules from an entity such as an SMF. The WTRU receives 510 a PDU to be transmitted in an uplink transmission and determines 515 a priority level of the PDU based on the WTRU Set Detection Rules and information associated with the PDU, e.g., PDU Set importance value in a header from an application. Next the WTRU may determine 520 a data radio bearer to use for transmitting the PDU based on the determined priority level. In this manner, unlike legacy systems, PDUs of a same QOS flow may be mapped to different DRBs based on their determined priority within a QOS flow using PDU Set Importance rules and values of various embodiments.

The WTRU PDU Set Detection Rules may be received by the WTRU in a PDU Session Establishment Accept message or a PDU Session Modification Command. The WTRU PDU Set Detection Rules may be sent by the WTRU NAS Layer to the WTRU SDAP Layer and may include a QFI which may be used by the WTRU to determine what QoS Flow to apply the WTRU PDU Set Detection Rules.

The WTRU PDU Set Detection Rules may include a Priority Determination Rule which indicates a value that should be compared to at least part of the header of a received PDU to determine a Priority Level and corresponding appropriate resource(s) to be used. In one embodiment, the WTRU may determine a QFI that is associated with a PDU and use the QFI to determine what WTRU PDU Set Detection Rule to use to determine the Priority Level of the packet. The determined priority level may also be used to determine a resource (e.g. logical channel) to use to transmit the PDU.

The Priority Level associated with 5G QOS characteristics indicates a priority in scheduling resources among QoS Flows and PDUs, in which the lowest Priority Level value corresponds to the highest priority. The Priority Level may be used to differentiate between QoS Flows and PDUs of the same WTRU, and it may also be used to differentiate between QoS Flows and PDUs of different WTRUs.

In the case of congestion, when all QoS requirements cannot be fulfilled for one or more QoS Flows, the Priority Level may be used to select for which QoS Flows and PDUs the QoS requirements are prioritized such that a QoS Flow or PDU with Priority Level value N is prioritized over QoS Flows or PDUs with higher Priority Level values (i.e. N+1, N+2, etc.). In the case of no congestion, the Priority Level should be used to define the resource distribution between QoS Flows and PDUs. In addition, the scheduler may prioritize QoS Flows and PDUs based on other parameters (e.g. resource type, radio condition) in order to optimize application performance and network capacity.

Every standardized 5QI is associated with a default value for the Priority Level (specified in QoS characteristics Table). Priority Level may also be signaled together with a standardized 5QI to the (R)AN, and if it is received, it may be used instead of the default value. Priority Level may also be signaled together with a pre-configured 5QI to the (R)AN, and if it is received, it may be used instead of the pre-configured value.

If PDU Set based QOS handling is used, PDU Set Importance to Priority Level Mapping Rules may be signaled to (R)AN, and if received, take precedence over the Priority Level that is associated with the QoS Flow and shall be used to assign a Priority Level to a PDU whose GTP-U header includes a PDU Set Importance value.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a wireless transmit receive unit (WTRU), the method comprising:
receiving packet data unit (PDU) set detection rules and an indication a quality of service (QOS) flow that is associated with the PDU set detection rules from a network entity;
receiving a first PDU and a second PDU associated with the QoS flow, from upper layers, for uplink transmission;
determining a first priority level of the first PDU and a second priority level of the second PDU, based on the PDU set detection rules and the indication the QoS flow is associated with the PDU set detection rules, wherein the first priority level is different than the second priority level; and
determining different forwarding treatments to transmit the first PDU and the second PDU based on the respective determined first priority level and second priority level.

2. The method of claim 1, wherein determining the first and the second priority level comprises inspecting a value in a header of the received first and second PDUs and determining the respective first and second priority level based on a corresponding value in the PDU set detection rules.

3. The method of claim 1, wherein:
the determined forwarding treatment for transmitting the first PDU comprises, assigning resources based on the determined first priority level; and
the determined forwarding treatment for the second PDU comprises, determining not to transmit the second PDU based on the determined second priority level.

4. The method of claim 1, wherein the PDU set detection rules are received in one of a PDU Session Establishment Accept message or a PDU Session Modification Command.

5. The method of claim 1, wherein the PDU set detection rules are received by a network access stratum (NAS) layer.

6. The method of claim 2, wherein the value comprises a PDU Set Importance value provided by an application layer.

7. The method of claim 1, wherein determining the respective first and second priority levels is performed by a service data adaptation protocol (SDAP) entity of the WTRU.

8. The method of claim 1, wherein the network entity comprises a session management function (SMF).

9. A wireless transmit receive unit (WTRU) comprising:
a transceiver; and
a processor in communication with the transceiver, wherein the processor and the transceiver are configured to:
receive packet data unit (PDU) set detection rules and an indication of a quality of service (QOS) flow that is associated with the PDU set detection rules from a network entity;
receive a first PDU and a second PDU associated with the QoS flow, from upper layers, for uplink transmission;
determine a first priority level of the first PDU and a second priority level of the second PDU, based on the PDU set detection rules and the indication the QoS flow is associated with the PDU set detection rules, wherein the first priority level is different than the second priority level; and
determine different forwarding treatments to transmit the first PDU and the second PDU based on the respective determined first priority level and second priority level.

10. The WTRU of claim 9, wherein,
the determined forwarding treatment for transmitting the first PDU comprises assigning resources based on the determined first priority level; and
the determined forwarding treatment for the second PDU comprises, determining not to transmit the second PDU based on the determined second priority level.

11. The WTRU of claim 9, wherein the processor is configured to determine the first and the second priority level by comparing a value in a header of the received first and second PDUs with a corresponding value in the PDU set detection rules.

12. The WTRU of claim 9, wherein the PDU set detection rules are received in one of a PDU Session Establishment Accept message or a PDU Session Modification Command.

13. The WTRU of claim 9, wherein the PDU set detection rules are received by a network access stratum (NAS) layer.

14. The WTRU of claim 11, wherein the value comprises a PDU Set Importance value provided by an application layer.

15. The WTRU of claim 9, wherein the WTRU further comprises a service data adaptation protocol (SDAP) entity to determine the first and the second priority levels.

16. The WTRU of claim 9, wherein the network entity comprises a session management function (SMF).
